(19) United States
(12) Patent Application Publication
(10) Pub. No.: US 2020/0275669 A1
(43) Pub. Date: Sep. 3, 2020

(54) METHOD FOR FABRICATION OF DOUGH SHEETS AND SYSTEMS, APPARATUSES, AND PRODUCTS THEREOF

(71) Applicant: AJINOMOTO FOODS NORTH AMERICA, INC., Ontario, CA (US)

(72) Inventor: Koichi KUNISHIMA, Ontario, CA (US)

(73) Assignee: AJINOMOTO FOODS NORTH AMERICA, INC., Ontario, CA (US)

(21) Appl. No.: 16/289,238

(22) Filed: Feb. 28, 2019

(51) Int. Cl. A21C 3/02; A23L 7/109; A21C 3/04; A21C 11/12; A21C 11/24

(52) U.S. Cl. CPC A21C 3/028; A23L 7/109; A21C 11/24; A21C 11/12; A21C 3/04

(57) ABSTRACT

A method of manufacturing a dough sheet, comprising providing a batch of dough, introducing the batch of dough to a pair of rollers, processing the dough through the pair of rollers to produce the dough sheet, and outputting the dough sheet from the pair of rollers. The pair of rollers is configured to transform the dough into the dough sheet, wherein a surface of each of the rollers of the pair of rollers is a grooved surface having a plurality of predetermined grooves. The predetermined grooves can run in a same direction as a direction of rotation of the roller, and the grooved surface has a predetermined surface roughness formed by the predetermined grooves.

### FIELD OF THE DISCLOSURE

The present disclosure relates to a method of dough sheet fabrication and, in particular, a method of rolling dough components into a dough sheet, and systems, apparatuses, and products thereof.

### SUMMARY

According to one or more embodiments of the disclosed subject matter, the present disclosure relates to a method of manufacturing a dough sheet, comprising providing a batch of dough, introducing the batch of dough to a pair of rollers, processing the dough through the pair of rollers to produce the dough sheet, and outputting the dough sheet from the pair of rollers, wherein the pair of rollers is configured to transform the dough into the dough sheet, wherein a surface of each of the rollers of the pair of rollers is a grooved surface having a plurality of predetermined grooves, the predetermined grooves running in a same direction as a direction of rotation of the roller, and wherein the grooved surface has a predetermined surface roughness formed by the predetermined grooves.

According to an embodiment, the present disclosure further relates to an apparatus for manufacturing a dough sheet, comprising a roller pair, the roller pair including two rollers configured to form the dough sheet from a dough mixture, a surface of each of the two rollers of the roller pair having a plurality of topographical features therein, wherein the dough mixture is mixed inside a mixer from a recipe of dough ingredients, and wherein the dough sheet has a predefined thickness.

Embodiments can also include methods of providing, making, and/or using apparatuses, systems, and products, or portions thereof, according to one or more embodiments of the disclosed subject matter.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a schematic of a system according to one or more embodiments of the disclosed subject matter.

FIG. 2 is a schematic of another system according to one or more embodiments of the disclosed subject matter.

FIG. 3 is a schematic of a pair of rollers according to one or more embodiments of the disclosed subject matter.

FIG. 4 is a schematic of a roller having a grooved surface, according to an exemplary embodiment of the present disclosure.

FIG. 5A is a cross-sectional schematic of a shape of a groove of a roller having a grooved surface according to one or more embodiments of the present disclosure.

FIG. 5B is a cross-sectional schematic of a shape of a groove of a grooved roller having a grooved surface according to one or more embodiments of the present disclosure.

FIG. 5C is a cross-sectional schematic of a shape of a groove of a grooved roller having a grooved surface according to one or more embodiments of the present disclosure.

FIG. 5D is a cross-sectional schematic of a shape of a groove of a grooved roller having a grooved surface according to one or more embodiments of the present disclosure.

FIG. 6A is an arrangement of a plurality of grooves of a grooved roller according to one or more embodiments of the present disclosure.

FIG. 6B is an arrangement of a plurality of grooves of a grooved roller according to an one or more embodiments of the present disclosure.

FIG. 6C is an arrangement of a plurality of grooves of a grooved roller according to one or more embodiments of the present disclosure.

FIG. 6D is an arrangement of a plurality of grooves of a grooved roller, according to one or more embodiments of the present disclosure.

FIG. 6E is an arrangement of a plurality of grooves of a grooved roller, according to one or more embodiments of the present disclosure.

FIG. 6F is an arrangement of a plurality of grooves of a grooved roller, according to one or more embodiments of the present disclosure.

FIG. 6G is an arrangement of a plurality of grooves of a grooved roller, according to one or more embodiments of the present disclosure.

FIG. 7 is an arrangement of a plurality of grooves of a plurality of grooved rollers, according to one or more embodiments of the present disclosure.

FIG. 8 is a flow chart of a method according to one or more embodiments of the disclosed subject matter.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising,” “including,” and “having” can be used interchangeably.

It is to be understood that terms such as “left,” “right,” “top,” “bottom,” “front,” “rear,” “side,” “height,” “depth,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Noodles can be used in a variety of food preparations and, therefore, are a staple food in many cultures. The time required to heat noodles by traditional methods, however, can limit the environs in which they can be enjoyed. For instance, the time required to heat water and boil a noodle can be such that, while the result may be a noodle with a predictable and desired taste and mouth feel, it is impractical in a business lunch room or similar setting where time is limited and convenience is paramount.

Accordingly, microwaveable-noodles have been introduced to obviate the above-described concerns. For instance, microwaveable-noodles can be heated rapidly, thereby providing a convenient and time-conscious solution. The process of microwaving a noodle, however, differs from that of traditional methods and, as such, produces a heated noodle with necessarily different properties. When noodles are heated with a cooking liquid, for example, microwaving increases the movement of water or water-based cooking liquid into voids within the noodle. As compared with traditional methods, this movement of fluids changes the structure of the noodle, often resulting in a noodle that fails to provide the structure and taste that consumers expect. While some have attempted to separate the heating of the noodle from the heating of the cooking liquid to avoid this outcome, efforts continue to fail in providing a convenient and rapid approach to food preparation.

Addressing the drawbacks of microwaveable-noodles requires an evaluation of the noodle production process. During a typical production process of a noodle, dough formed by mixing can be transformed via rolling, among others, to produce a noodle sheet that can be cut by appropriate means to output a noodle of a desired shape and size. During the transformation from dough to noodle sheet, however, voids, or air pockets, can be formed in the noodle sheet as a result of being squeezed (or, effectively, trapped) between two rollers. The resulting noodle sheet, therefore, has a density that is dependent, in part, on the rotational speed of the two rollers and the composition of the dough. In view of the above, when heat is introduced by way of a microwave, the voids within the dough can be filled with water or water-based cooking liquid such that the integrity of the structure of the needle becomes compromised (e.g. soft and unpalatable). The present disclosure, therefore, aims to describe a noodle fabrication process that decreases the density of a noodle sheet such that, during microwaving, the structure and taste of each noodle can be maintained.

Embodiments of the present disclosure, therefore, are directed generally to noodle fabrication in the food industry. Moreover, the present disclosure is directed to a method of fabrication of a noodle sheet including a plurality of rollers being positioned adjacent each other such that a dough input from one side of a clearance between two rollers is transformed to a dough output at a second side of the clearance between the two rollers. More specifically, embodiments of the present disclosure describe topographical features on a surface of the plurality of rollers, the topographical features being disposed on the surface of each roller in order to interact with the dough.

According to an embodiment, the present disclosure describes a noodle fabrication process including a plurality of rollers having topographical features that interact with a dough, the topographical features configured to increase the density of the dough and resultant noodle sheet, the noodle sheet having an improved structure and taste.

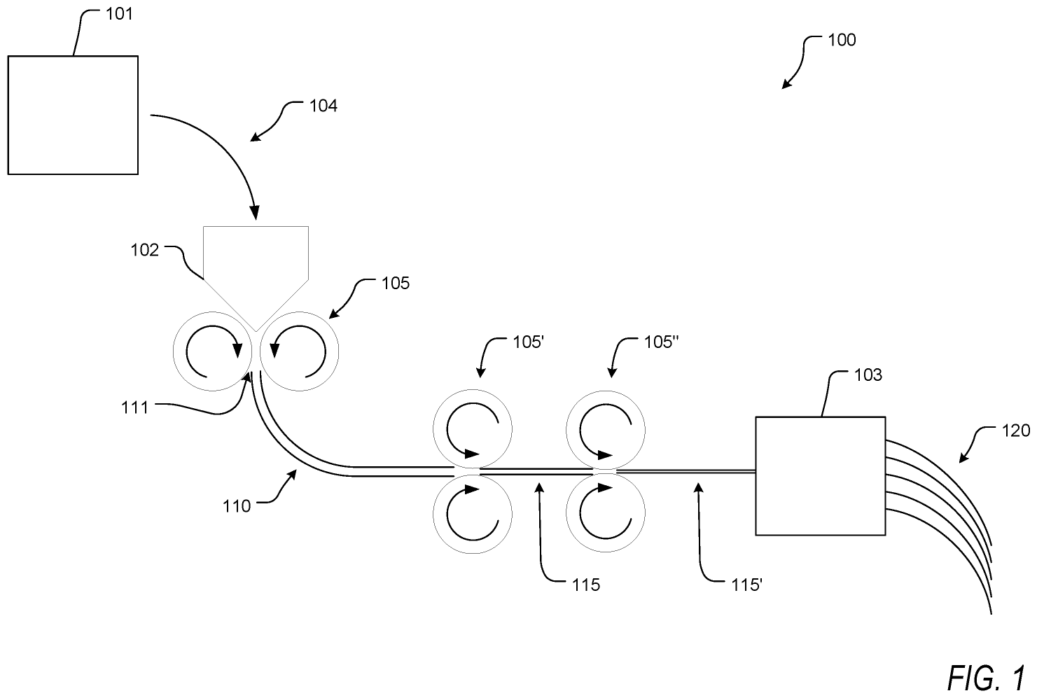

Turning now to the figures, FIG. 1 shows a schematic of a noodle fabrication process 100. The noodle fabrication process 100 of FIG. 1 describes, at a high level, the fabrication of a single noodle sheet and resulting noodles; however, a noodle sheet may be fabricated from a plurality of noodle sheets and combined via a plurality of rollers in a manner similar to that described herein, mutatis mutandis.

Initially, raw ingredients of dough can be added to a mixer 101 and combined to form dough 104. The dough 104, or dough mixture, can be added to a hopper 102 in order to be directed into a clearance area 111 between a pair of rollers 105 of a plurality of rollers. The pair of rollers 105 of the plurality of rollers can be made of a material including, among others, stainless steel, and can be configured to rotate in opposite directions such that the dough 104 directed from the hopper 102 can be compressed as it passes, or is ‘pulled,’ through the clearance area 111 between the rollers of the pair of rollers 105. According to an embodiment, and depending upon a thickness of the clearance area 111, an output from the pair of rollers 105 can form a noodle sheet that is ready to be cut into noodles 120 by a noodle cutter 103. In another embodiment, the output of the pair of rollers 105 is a dough sheet 110 that is of an undesirable thickness for cutting via the noodle cutter 103. A step-wise reduction in the thickness of the dough may be applied via subsequent interactions with rollers. As shown in FIG. 1, the pair of rollers 105 may be a first pair of rollers 105 and the dough sheet 110 output from interaction with the first pair of rollers 105 may subsequently interact with a second pair of rollers 105′. The second pair of rollers 105′ may have a clearance area smaller than the clearance area 111 of the first pair of rollers 105. The output of the second pair of rollers 105′ can be a first noodle sheet 115 having an attendant thickness smaller than the thickness of the dough sheet 110. The first noodle sheet 115 can then be delivered to a third pair of rollers 105″, the third pair of rollers 105″ having a clearance area smaller than the clearance area of the second pair of rollers 105′. As before, the output of the third pair of rollers 105″ can be a second noodle sheet 115′ having a thickness smaller than the thickness of the first noodle sheet 115. The second noodle sheet 115′ can be of a desired thickness of a noodle product and can be delivered to the noodle cutter 103 for cutting into noodles 120. In an embodiment, the desired thickness of the noodle product can be between 8 mm and 15 mm. In an example, the desired thickness of the noodle product can be 11 mm.

It can be appreciated that the number of pairs of rollers, as described above, can be adjusted according to the at-issue intended noodle product without deviating from the spirit of the present disclosure.

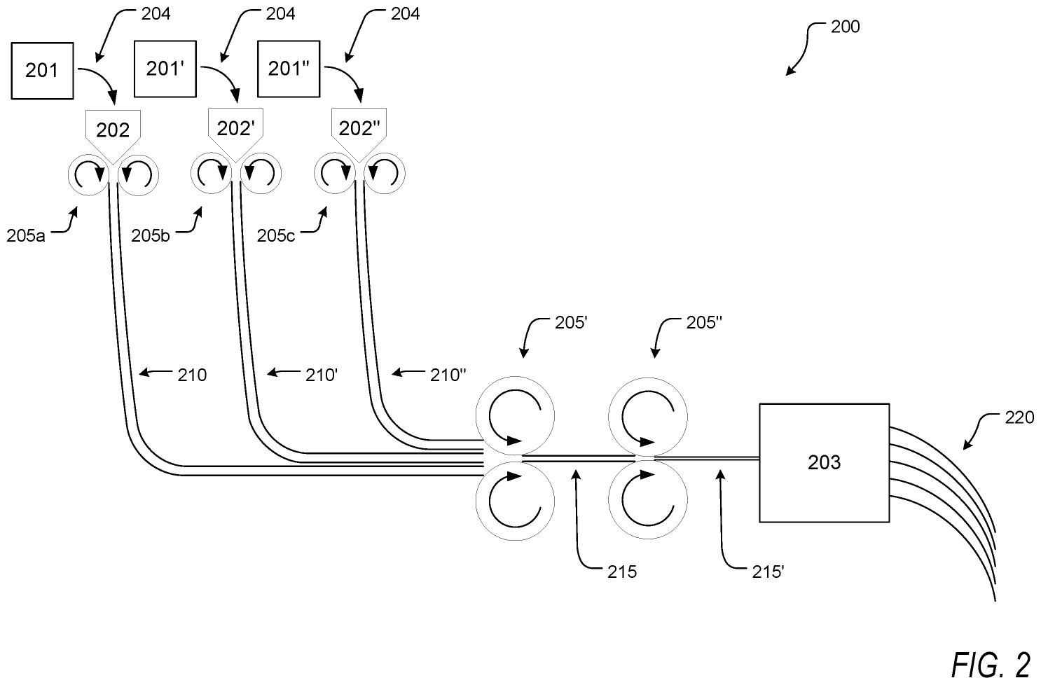

FIG. 2, like FIG. 1, provides a high-level summary of a noodle fabrication process 200. Unlike FIG. 1, FIG. 2 describes fabrication of a noodle sheet being comprised of a plurality of noodle sheets. The output of such a process can be a noodle having multiple layers with different properties, such as a noodle with a firmer exterior and a softer interior.

To this end, with reference to FIG. 2, raw ingredients of dough can be added to each of a plurality of mixers 201, 201′, 201″ and combined to form a respective plurality of doughs 204, 204′, 204″. Though described herein as three mixers, it can be appreciated that any number of mixers can be implemented as appropriate for an intended noodle product without deviating from the spirit of the present disclosure. The plurality of doughs 204, 204′, 204″ can then be added to a respective plurality of hoppers 202, 202′, 202″ in order to be directed into clearance areas between respective pairs of rollers 205a, 205b, 205c of a plurality of rollers. The respective pairs of rollers 205a, 205b, 205c of the plurality of rollers can be configured to rotate in opposite directions such that the respective doughs 204, 204′, 204″ directed from each hopper 202, 202′, 202″ can be compressed as they pass, or are ‘pulled,’ through each clearance area of the respective pairs of rollers 205a, 205b, 205c. According to an embodiment, an output from each of the pairs of roller 205a, 205b, 205c forms a corresponding dough sheet 210, 210′, 210″. The corresponding dough sheets 210, 210′, 210″ can then be combined and fed into a clearance area of a second pair of rollers 205′ to begin a step-wise reduction in thickness of the combined dough sheets 210, 210′, 210″. The clearance area of the second pair of rollers 205′ can be smaller than the clearance area of the initial pairs of rollers 205a, 205b, 205c. The output of the second pair of rollers 105′ can be a first noodle sheet 215 having a thickness smaller than the thickness of the combined dough sheets 205a, 205b, 205c. This tri-layered, first noodle sheet 215 can then be delivered to a third pair of rollers 205″, the third pair of rollers 205″ having a clearance area smaller than the clearance area of the second pair of rollers 205′. As before, the output of the third pair of rollers 205″ can be a second noodle sheet 215′ having a thickness smaller than the first noodle sheet 215. The second noodle sheet 215′ can be of a desired thickness of a noodle product and can be delivered to a noodle cutter 203 for cutting into noodles 220.

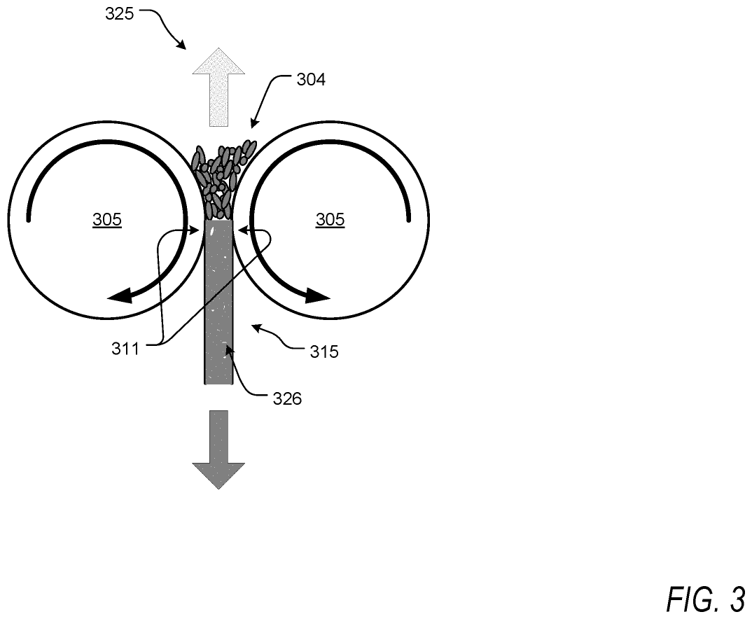

FIG. 3 is a schematic of a pair of rollers 305 of the noodle fabrication process described in FIG. 1 and FIG. 2. The pair of rollers 305 in FIG. 3, in particular, reflects a first pair of rollers 305 that receives a mixture of dough 304 from a mixer via a hopper. Moreover, FIG. 3 demonstrates a moment of the noodle fabrication process wherein voids (e.g., air) can be introduced. The voids may be responsible, in part, for extreme softening of the noodle following microwaving. These voids can be introduced as the dough 304 is pulled through a clearance area 311 between the pair of rollers 305 that are rotating against each in order to compress and ‘pull’ the dough 304 through the pair of rollers 305. As the dough 304 is being compressed within the clearance area 311 between the pair of rollers 305, air 325 is squeezed out of the dough 304 and escapes to the environment. Under traditional conditions, the escaping air 325 may be a fraction of the air initially ‘trapped’ within the mixed dough 304. Accordingly, an output of the pair of rollers 305 can be a dough sheet 315 containing a plurality of voids 326 that can adversely impact the quality of the noodle upon microwave heating.

According to an embodiment, and as proposed above, the present disclosure relates to rollers of pairs of rollers having topological features that can increase the fraction of escaped air 325 from the dough mixture 304 and minimize the fraction of voids of the plurality of voids 326 of an output dough sheet 315.

To this end, and with reference now to FIG. 4, a roller 405 of a pair of rollers can be substantially cylindrical and be rotatable about a longitudinal axis 406 of the roller 405. The roller 405 can have a surface 434 and can have a plurality of topographical features 430 circumferentially disposed thereon. The surface 434 of the roller 405 can have a surface roughness, as measured by topographical techniques such as, among others, optical profilometry or contacting surface roughness gauges, of between Ra7 μm to Ra20 μm. In an example, the surface roughness of the surface 434 of the roller 405 can be Ra15 μm. Each of the topographical features 430, or grooves, of the plurality of grooves can be continuous in a circumferential direction and oriented relative to a rotational axis, or the longitudinal axis 406, of the roller 405. In an embodiment, a radius 444 of each groove 430 of the plurality of grooves can be oriented perpendicularly to the longitudinal axis 406 of the roller 405. A perpendicular orientation of the radius 444 of each groove 430 of the plurality of grooves allows for, during dough processing, air to travel in a straight line away for the direction of movement of the dough mixture and, thus, to escape from the dough mixture. In an embodiment, the orientation of the radius 444 of each groove 430 can be the same relative to the longitudinal axis 406 of the roller 405. Alternatively, a mixture of orientations of radii 444 of the grooves 430 can be implemented, wherein a fraction of the radii 444 can be perpendicular, while the balance of the radii 444 can be askew. Further, each of the grooves 430 of the plurality of grooves can be separated by an inter-groove distance 431 (i.e., inter-topographical feature distance, or inter-feature distance). As will be described later, each groove 430 can be disposed at regular intervals along the longitudinal axis 406 of the roller 405 can be irregularly spaced along the longitudinal axis 406 of the roller 405, according to the desired effect thereof.

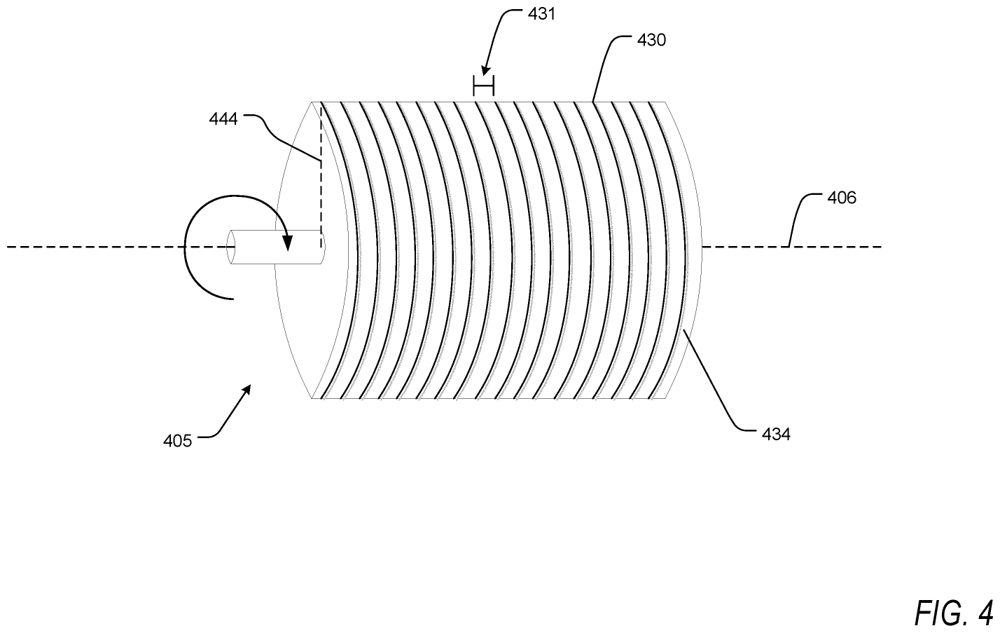

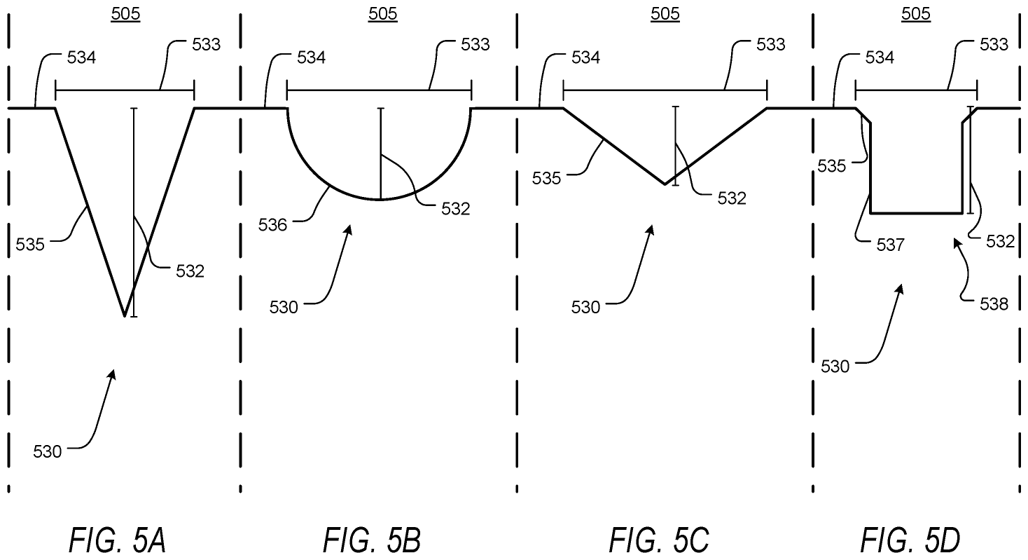

According to an embodiment, each of the grooves 430 of the plurality of grooves of the roller 405 of FIG. 4 can have a pre-defined cross sectional shape relative to the longitudinal axis 406 of the roller 405. As shown in FIG. 5A to FIG. 5D, the cross-sectional shape of each groove can be any shape such that a desired fraction of air can be forced out of a dough mixture during compression and ‘pulling’ through a first pair of rollers. For brevity, it can be appreciated that each of FIG. 5A to FIG. 5D comprise a roller 505, a roller surface 534, and a groove 530 disposed on the roller surface 534. As before, the groove 530 can be one of a plurality of grooves disposed along a longitudinal axis of the roller 505, each groove 530 being a continuous groove 530 that is circumferentially disposed about the roller 505.

With reference now to FIG. 5A, the groove 530 can have a cross-sectional shape that is triangular 535. The triangular cross-sectional shape 535 of the groove 530 can have a first dimension, or width 533, and a second dimension, or height 532, that are pre-determined. Each groove 530 of a plurality of grooves can have a constant width 533 and/or a constant height 532. Alternatively, as demonstrated by FIG. 5C, the width 533 and the height 532 of each groove 530 of the plurality of grooves can vary, as might be consistent with a desired noodle.

With reference now to FIG. 5B, the groove 530 can have a cross-sectional shape that is curved or, for example, hemispherical 536. In the case of a hemispherical 536 cross section, the height 532 and width 533 of the groove 530 can be identical and can be defined by a radius of the sphere that defines the hemisphere. Each groove 530 of a plurality of grooves can have a hemispherical 536 cross section having a constant radius or, alternatively, grooves 530 with varying radii, as desired.

With reference now to FIG. 5C, similarly to FIG. 5A, the groove 530 can have a cross-sectional shape that is triangular 535. The triangular cross-sectional shape 535 of the groove 530 can have a width 533 and a height 532 that are pre-determined. As compared to FIG. 5A, the width 533 of the triangular 535 cross section of FIG. 5C can be larger and the height 532 of the triangular 535 cross section of FIG. 5C is smaller, indicative of the variation possible within grooves 530 of the plurality of grooves.

With reference now to FIG. 5D, the groove 530 can be a combinatorial groove 538 having features of both a rectangular 537 cross section and a triangular 535 cross section. For example, the groove 530 can have a substantially rectangular 537 cross-sectional shape but can have a chamfered surface where the groove 530 meets the surface 534 of the roller. This chamfered surface can have a substantially triangular 535 shape. Considered together, as before, each groove 530 of a plurality of grooves can have a constant width 533 and a constant height 532 or, alternatively, variations in in widths 533 and heights 532 according to a desired noodle outcome.

Notably, each of the above-described cross-sectional shapes is configured to prevent the trapping of dough mixture, and thus, air therein, within narrow spaces of the each of the grooves 530 adjoins the surface 534 of the roller 505. For example, the triangular 535 cross section of the chamfered surface of the groove 530 of FIG. 5D can allow for the escape of air during the compression and ‘pulling’ of the dough mixture.

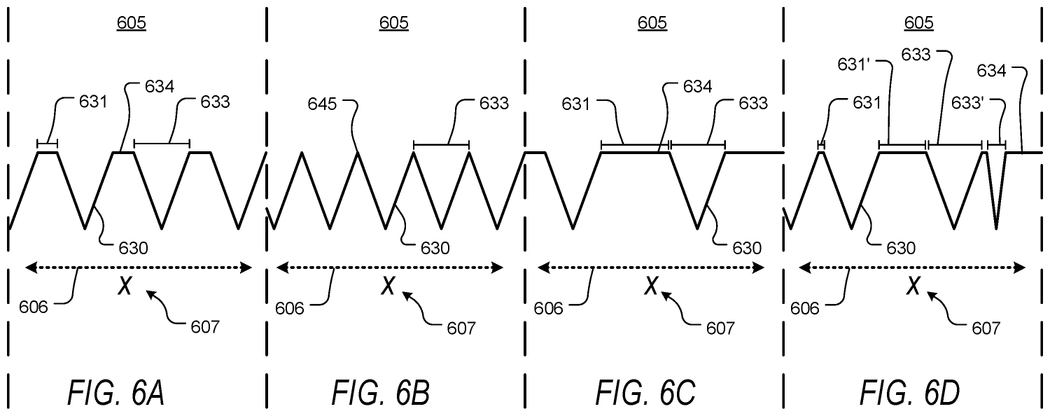

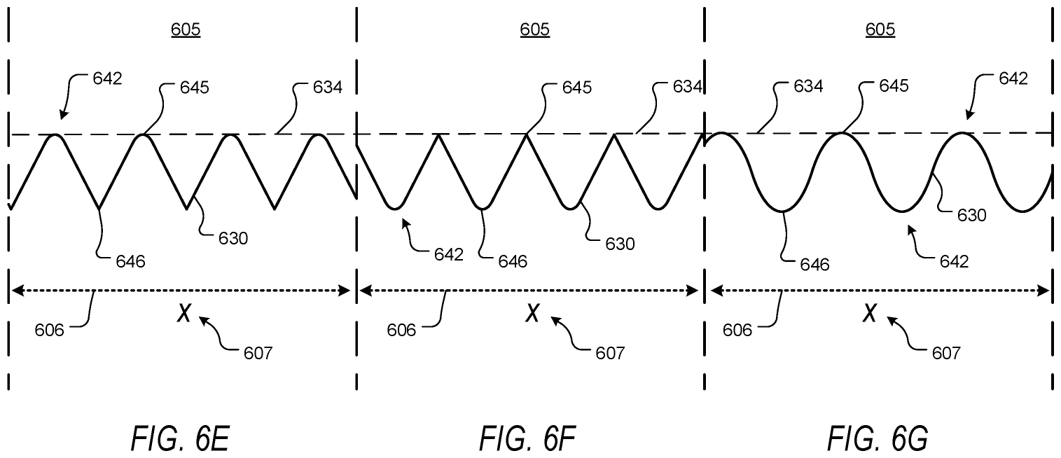

With reference now to FIG. 6A to FIG. 6G, each groove 630 of the plurality of grooves can be separated by an inter-groove distance 631. The inter-groove distance 631 can be regular, irregular, or a combination thereof through the plurality of grooves. For brevity, each of FIG. 6A to FIG. 6D includes a roller 605 having a surface 634 and a plurality of grooves 630 disposed along a longitudinal axis 606, the plurality of grooves 630 having a triangular cross-sectional shape with a constant height. Moreover, the plurality of grooves 630 can be defined as a unit length 607, or series of grooves, the series of the plurality grooves 630 being a repeatable unit along the longitudinal axis 606 of the roller 605.

As shown in FIG. 6A, each groove 630 of the series 607 can have an inter-groove distance 631 that is, in an example, constant. Moreover, each groove 630 can have a width 633 that remains constant along the length of the series 607 of the plurality of grooves.

As shown in FIG. 6B, each groove 630 of the series 607 can have a width 633 and can be disposed along the surface of the roller 605 such that the grooves are adjacent. In such case, a base 645 of first groove 630 can abut the base 645 of a second groove 630, and the inter-groove distance 631 can be zero.

As shown in FIG. 6C, each groove 630 of the series 607 can have a width 633 and an inter-groove distance 631 that is non-zero along the length of the series 607 of the plurality of grooves. Much like FIG. 6A, the inter-groove distance 631 can be a consistent value, though, unlike FIG. 6A the inter-groove distance 631 can be larger, creating a series 607 of the plurality of grooves to have fewer grooves 630 per ‘unit length.’

As shown in FIG. 6D, each groove 630 of the series 607 can have a width 633 and an inter-groove distance 631 that can change along the length of the series 607 of the plurality of grooves and, in turn, change along the length of the roller 605. For example, the inter-groove distance 631, 631′ can be of varying lengths, and the width 633, 633′ of each groove can vary, accordingly, allowing for increased customization in the design of the plurality of grooves of the roller 605.

According to an embodiment, and as alluded to above, the cross-sectional shape of groove can be combinatorial and can be curved, as shown in FIG. 6E to FIG. 6G. For brevity, each of FIG. 6E to FIG. 6G includes a roller 605 having a surface 634 and a plurality of grooves 630 disposed along a longitudinal axis 606. Moreover, the plurality of grooves 630 can be defined as a unit length 607, or series of grooves, the series of the plurality grooves 630 being a repeatable unit along the longitudinal axis 606 of the roller 605.

With reference to FIG. 6E, each groove 630 can have a cross-sectional shape that is substantially curved, or splined. The groove 630 can have a splined surface at a base 645 proximate the surface 634 of the roller 605, thus forming a valley 642, and can abut an adjacent groove 630 at an apex 646.

With reference to FIG. 6F, each groove 630 can have a cross-sectional shape that is substantially curved, or splined. The groove 630 can abut an adjacent groove 630 at a base 645 proximate the surface 634 of the roller 605 and can have a splined surface at an apex 646, thus forming a valley 642.

With reference to FIG. 6G, each groove 630 can have a cross-sectional shape that is substantially curved, or splined. The groove 630 can join an adjacent groove 630 at a base 645 proximate the surface 634 of the roller 605 and can have a splined surface, forming a valley 642, at both the base 645 and an apex 646 of the groove 630.

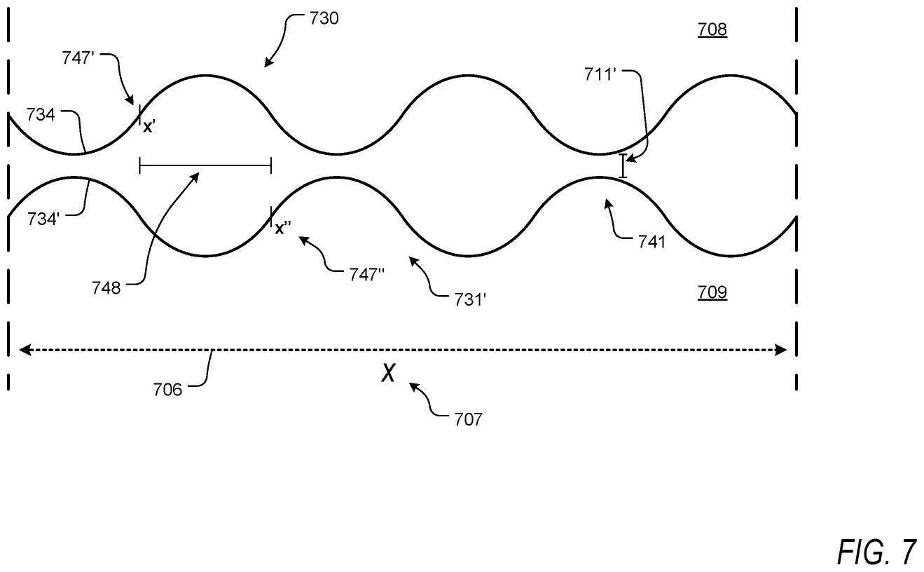

The splined grooves 630 of FIG. 6G reflect a sinusoidal arrangement that, in an embodiment, can serve as a surface 634 of a roller 605 of a pair of rollers. To this end, and with reference to FIG. 7, a pair of rollers can include a first roller 708 and a second roller 709 positioned such that a surface 734 of the first roller 708 and a surface 734′ of the second roller are opposing and separated by a clearance distance 711′ defining a clearance area. Each of the rollers 708, 709 includes a plurality of grooves 730, 730′ disposed along a longitudinal axis 706 of the rollers 708, 709. Moreover, the plurality of grooves 730 can be defined as a unit length 707, or series of grooves, the series of the plurality grooves 730 being a repeatable unit along the longitudinal axis 706 of the rollers 708, 709.

In an embodiment, the plurality of grooves 730 of each of the first roller 708 and the plurality of grooves 731′ of the second roller 709 can be arranged such that an inflection point 747′ of a groove of the first roller 708 aligns with an inflection point 747″ of a groove of the second roller 709. It can be appreciated that the inflection points 747′, 747″ do not need to be aligned and, therefore, in an embodiment and as shown in FIG. 7, the rollers 708, 709 can be configured such that corresponding inflection points 747′, 747″ are separated by a groove shift distance 748. The groove shift distance 748 can be a relative lateral shift of a groove of a roller. The groove shift distance 748 can equate to, in an example, a 180° phase shift of a waveform. The above-described arrangement of the rollers 708 can be dependent upon the intended outcome. For instance, the groove shift distance 748 and the clearance distance 711′ can be any distances such that a desired dough sheet, or noodle sheet, is output. Moreover, a cross-sectional shape of grooves of the plurality of grooves of the first roller 708 and the second roller 709 can be congruous or can be incongruous according to the methods outlined above with respect to the FIGS. 6A-6G.

Considering the pair of rollers of FIG. 7 in view of the noodle fabrication process of FIG. 1 and FIG. 2, the spirit of the present disclosure can be appreciated. For instance, the pair of rollers of FIG. 7 can be the first set of rollers of FIG. 1, wherein a dough mixture is first delivered from a hopper. With reference to FIG. 3, the relative arrangement of corresponding grooves of the pair of rollers of FIG. 7 can allow the delivered dough mixture to be compressed and ‘pulled’ through a clearance area of the pair of rollers in such a way that air within the dough mixture can be released and escape within the grooves of each of the pair of rollers. In doing so, the resultant dough sheet, or noodle sheet in cases, can have a density higher than that achievable by typical approaches.

In addition to the above, a grooved roller of the present disclosure was evaluated experimentally in the context of established rollers for the same purpose. To this end, the grooved roller of the present disclosure was evaluated against a shot blasted roller and a standard roller. Evaluations included surface roughness measurements, visual inspection, sheet length measurements, and density evaluation.

The same dough mixture was evaluated on each of the three rollers described above. The dough mixture comprised flour, starch, gluten, water, salt, egg white, kansui, and xanthan gum and was prepared by mixing in a mixer under vacuum for a 3.5 minutes following a 3 minute resting period. With the dough mixture prepared, the dough mixture was split and distributed to each of the grooved roller, the shot blasted roller, and the standard roller. The resulting dough sheet, or noodle sheet, was assayed by visual inspection and via measurement to determine sheet length, density, and hardness.

First, each roller was evaluated to determine the surface roughness thereof. It can be appreciated that the surface roughness of a surface such as the rollers in question can be determined via topographical techniques that include, for example, scanning electron microscopy and non-contact surface profilometry. The surface roughness of the grooved roller, the shot blasted roller, and the standard roller were determined, via HANDYSURF E-35B (TOKYO SEIMITSU CO., LTD.), to be Ra13.0 Ra5.0˜6.0 μm, and Ra2.2 μm, respectively.

As discussed, a dough sheet, or noodle sheet, was prepared using each of the above-evaluated rollers. The dough sheet was measured to have an average thickness of 11 mm.

A visual inspection revealed that a smoother surface can be generated with the grooved roller. Further, fewer cracks and/or holes were observed in the grooved roller dough sheet as compared with the dough sheets from the shot blasted roller and the standard roller. These observations, together, suggests and improved homogeneity and increased density of the dough sheet formed via the grooved roller.

Noodle sheet length, indicative of the density of the output of each pair of rollers, was measured every 10 seconds of rolled dough to. After 10 seconds, the length of a noodle sheet prepared via grooved roller, shot blasted roller, and standard roller was determined to be 13.3 cm, 17.8 cm, and 16.5 cm, respectively. This initial analysis indicates, therefore, that the grooved roller increases density within the dough sheet as compared with the shot blasted roller and the standard roller.

Density was evaluated by a liquid quick. To accomplish this, each noodle sheet was cut into rectangular shapes having dimensions of 10 mm×50 mm×11 mm (length×width×thickness) and soaked within 50 mL canola oil. The cubic volume and density of each noodle sheet was calculated therefrom and compared, accordingly. For example, as shown in Table 1, it was observed that the density of the noodle sheet formed by the grooved roller was higher than the density of the shot blasted roller noodle sheet and the standard roller noodle sheet.

TABLE 1
Density Measurement

| No. | Name | Density (mL/mm³) |
|---|---|---|
| 1 | Grooved roller noodle sheet | 1.30 |
| 2 | Shot blasted roller noodle sheet | 1.28 |
| 3 | Standard roller noodle sheet | 1.22 |

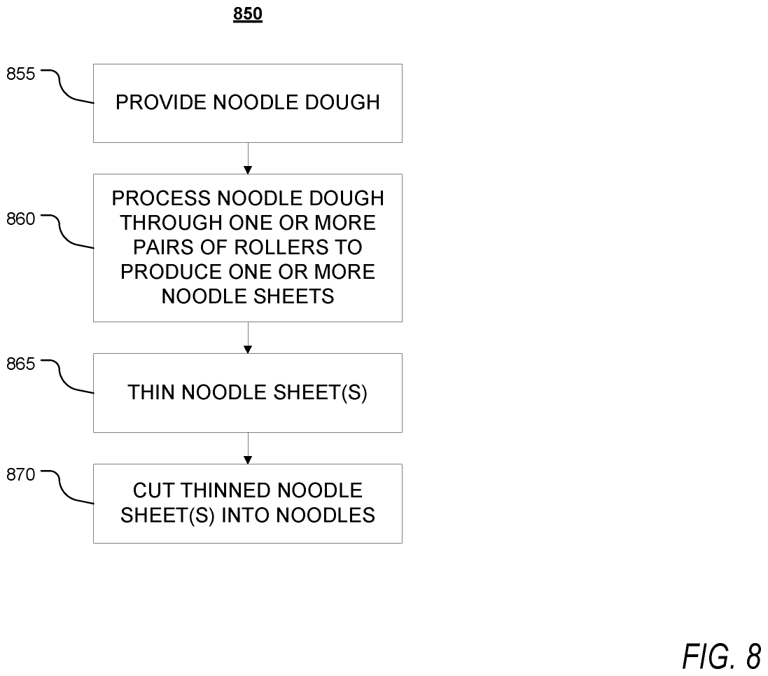

FIG. 8 is a flow chart of a method 850 of a noodle fabrication process, according to one or more embodiments of the disclosed subject matter.

Initially, at step 855 of method 850, mixed noodle dough is provided through the hopper to a first pair of rollers. As discussed, the first pair of rollers can be one of a series of pairs of rollers according to the desired thickness and/or layers of the output noodle sheet.

At step 860 of method 850, the mixed noodle dough is processed through the first pair of rollers and a dough sheet, or noodle sheet, is output.

Next, at step 865 of method 850, the output dough sheet, or noodle sheet, may be subsequently processed through additional pairs of rollers until a noodle sheet of a desired thickness is obtained.

At step 870 of method 850, having obtained a noodle sheet of a desired thickness at step 865, the noodle sheet can be cut by a noodle cutter into a final noodle shape, the noodle shape then may be ready for consumption as a staple food.

Embodiments of the disclosed subject matter may also be as set forth according to the parentheticals in the following paragraphs.

(1) A method of manufacturing a dough sheet, comprising providing a batch of dough, introducing the batch of dough to a pair of rollers, processing the dough through the pair of rollers to produce the dough sheet, and outputting the dough sheet from the pair of rollers, wherein the pair of rollers is configured to transform the dough into the dough sheet, wherein a surface of each of the rollers of the pair of rollers is a grooved surface having a plurality of predetermined grooves, the predetermined grooves running in a same direction as a direction of rotation of the roller, and wherein the grooved surface has a predetermined surface roughness formed by the predetermined grooves.

(2) The method of manufacture according to (1), wherein the predetermined surface roughness is a value ranging from Ra7 μm to Ra20 μm.

(3) The method of manufacture according to either (1) or (2), further comprising another pair of rollers configured to receive another batch of dough and produce another dough sheet for combination with said dough sheet to make the dough sheet.

(4) The method of manufacture according to any one of (1) to (3), wherein the grooved surface include a plurality of topographical features separated by an inter-feature di stance.

(5) The method of manufacture according to any one of (1) to (4), wherein the grooved surface include a plurality of topographical features at equal intervals along a longitudinal axis of the roller.

(6) The method of manufacture according to any one of (1) to (5), wherein the grooved surface includes a plurality of topographical features at unequal intervals along a longitudinal axis of the roller.

(7) The method of manufacture according to any one of (1) to (6), wherein the grooved surface includes a plurality of topographical features, each of the plurality of topographical features having a radius that is generally perpendicular to a longitudinal axis of the roller.

(8) The method of manufacture according to any one of (1) to (7), wherein the grooved surface includes a plurality of topographical features forming a continuous surface.

(9) The method of manufacture according to any one of (1) to (8), wherein the grooved surface includes a plurality of topographical features, said plurality of topographical features being concave.

(10) The method of manufacture according to any one of (1) to (9), wherein the grooved surface includes a plurality of topographical features, a connection between adjacent topographical features of said plurality of topographical features being curved.

(11) The method of manufacture according to any one of (1) to (10), further comprising guiding a plurality of the dough sheets provided by said outputting the dough sheet into a subsequent pair of a series of roller pairs, each said dough sheet of the plurality of dough sheets subsequently arranged on the prior dough sheet such that respective predefined thicknesses are aligned, the subsequent pair of the series of roller pairs being configured to form a single dough sheet from the plurality of dough sheets, wherein the single sheet is multilayered, and wherein at least one layer of the multilayered single sheet has been previously formed via the at least one pair of the series of roller pairs having the plurality of topographical features therefrom.

(12) The method of manufacture according to any one of (1) to (11), wherein the predetermined grooves of a first roller of the pair of rollers are aligned with the predetermined grooves of a second roller of the pair of rollers.

(13) An apparatus for manufacturing a dough sheet, comprising a roller pair, the roller pair including two rollers configured to form the dough sheet from a dough mixture, a surface of each of the two rollers of the roller pair having a plurality of topographical features therein, wherein the dough mixture is mixed inside a mixer from a recipe of dough ingredients, and wherein the dough sheet has a predefined thickness.

(14) The method of manufacture according to (13), wherein each one of the plurality of topographical features of a first roller of the roller pair is aligned with a corresponding one of the plurality of topographical features of a second roller of the roller pair.

(15) The apparatus according to either (13) or (14), wherein each one of the plurality of topographical features of a first roller of the roller pair is laterally offset from a corresponding one of the plurality of topographical features of a second roller of the roller pair.

(16) The apparatus according to any one of (13) to (15), wherein the surface of the two rollers of the roller pair having the plurality of topographical features therein is configured to have a predefined surface roughness.

(17) The apparatus according to any one of (13) to (16), wherein each of the plurality of topographical features is continuous along a circumference of a roller of the roller pair.

(18) The apparatus according to any one of (13) to (17), wherein each of the plurality of topographical features is at equal intervals along a longitudinal axis of a roller of the roller pair.

(19) The apparatus according to any one of (13) to (18), wherein each of the plurality of topographical features is at unequal intervals along a longitudinal axis of a roller of the roller pair.

(20) The apparatus according to any one of (13) to (19), further comprising a subsequent roller pair, the subsequent roller pair including a subsequent two rollers configured to form a subsequent dough sheet from a plurality of dough sheets, each dough sheet of the plurality of dough sheets being subsequently arranged on the prior dough sheet such that respective predefined thicknesses are aligned, wherein the subsequent dough sheet is a multilayer dough sheet, and wherein at least layer of the multilayered dough sheet has been formed via the subsequent roller pair having the plurality of topographical features therein.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of manufacturing a dough sheet, comprising:
providing a batch of dough;
introducing the batch of dough to a pair of rollers;
processing the dough through the pair of rollers to produce the dough sheet; and
outputting the dough sheet from the pair of rollers,
wherein the pair of rollers is configured to transform the dough into the dough sheet,
wherein a surface of each of the rollers of the pair of rollers is a grooved surface having a plurality of predetermined grooves, the predetermined grooves running in a same direction as a direction of rotation of the roller, and
wherein the grooved surface has a predetermined surface roughness formed by the predetermined grooves.

2. The method of manufacture according to claim 1, wherein the predetermined surface roughness is a value ranging from Ra7 μm to Ra20 μm.

3. The method of manufacture according to claim 1, further comprising another pair of rollers configured to receive another batch of dough and produce another dough sheet for combination with said dough sheet to make the dough sheet.

4. The method of manufacture according to claim 1, wherein the grooved surface include a plurality of topographical features separated by an inter-feature distance.

5. The method of manufacture according to claim 1, wherein the grooved surface include a plurality of topographical features at equal intervals along a longitudinal axis of the roller.

6. The method of manufacture according to claim 1, wherein the grooved surface includes a plurality of topographical features at unequal intervals along a longitudinal axis of the roller.

7. The method of manufacture according to claim 1, wherein the grooved surface includes a plurality of topographical features, each of the plurality of topographical features having a radius that is generally perpendicular to a longitudinal axis of the roller.

8. The method of manufacture according to claim 1, wherein the grooved surface includes a plurality of topographical features forming a continuous surface.

9. The method of manufacture according to claim 1, wherein the grooved surface includes a plurality of topographical features, said plurality of topographical features being concave.

10. The method of manufacture according to claim 1, wherein the grooved surface includes a plurality of topographical features, a connection between adjacent topographical features of said plurality of topographical features being curved.

11. The method of manufacture according to claim 1, further comprising:
guiding a plurality of the dough sheets provided by said outputting the dough sheet into a subsequent pair of a series of roller pairs, each said dough sheet of the plurality of dough sheets subsequently arranged on the prior dough sheet such that respective predefined thicknesses are aligned, the subsequent pair of the series of roller pairs being configured to form a single dough sheet from the plurality of dough sheets,
wherein the single sheet is multilayered, and
wherein at least one layer of the multilayered single sheet has been previously formed via the at least one pair of the series of roller pairs having the plurality of topographical features therefrom.

12. The method of manufacture according to claim 1, wherein the predetermined grooves of a first roller of the pair of rollers are aligned with the predetermined grooves of a second roller of the pair of rollers.

13. An apparatus for manufacturing a dough sheet, comprising:
a roller pair, the roller pair including two rollers configured to form the dough sheet from a dough mixture, a surface of each of the two rollers of the roller pair having a plurality of topographical features therein,
wherein the dough mixture is mixed inside a mixer from a recipe of dough ingredients, and
wherein the dough sheet has a predefined thickness.

14. The method of manufacture according to claim 13, wherein each one of the plurality of topographical features of a first roller of the roller pair is aligned with a corresponding one of the plurality of topographical features of a second roller of the roller pair.

15. The apparatus according to claim 13, wherein each one of the plurality of topographical features of a first roller of the roller pair is laterally offset from a corresponding one of the plurality of topographical features of a second roller of the roller pair.

16. The apparatus according to claim 13, wherein the surface of the two rollers of the roller pair having the plurality of topographical features therein is configured to have a predefined surface roughness.

17. The apparatus according to claim 13, wherein each of the plurality of topographical features is continuous along a circumference of a roller of the roller pair.

18. The apparatus according to claim 13, wherein each of the plurality of topographical features is at equal intervals along a longitudinal axis of a roller of the roller pair.

19. The apparatus according to claim 13, wherein each of the plurality of topographical features is at unequal intervals along a longitudinal axis of a roller of the roller pair.

20. The apparatus according to claim 13, further comprising:
a subsequent roller pair, the subsequent roller pair including a subsequent two rollers configured to form a subsequent dough sheet from a plurality of dough sheets, each dough sheet of the plurality of dough sheets being subsequently arranged on the prior dough sheet such that respective predefined thicknesses are aligned,
wherein the subsequent dough sheet is a multilayer dough sheet, and
wherein at least layer of the multilayered dough sheet has been formed via the subsequent roller pair having the plurality of topographical features therein.
